(19) United States
(12) Patent Application Publication
(10) Pub. No.: US 2010/0244312 A1
(43) Pub. Date: Sep. 30, 2010

(54) MOLD FOR THE MANUFACTURE OF CERAMIC PRODUCTS

(75) Inventor: Vasco MAZZANTI, Imola (IT)

Correspondence Address: Pearne & Gordon LLP, 1801 East 9th Street, Suite 1200, Cleveland, OH, 44114-3108, US

(73) Assignee: SACMI COOPERATIVA MECCANICI IMOLA SOCIETA' COOPERATIVA, Imola (Bologna) (IT)

(21) Appl. No.: 12/732,400

(22) Filed: Mar. 26, 2010

(30) Foreign Application Priority Data
Mar. 31, 2009 (IT) BO2009A000203

(51) Int. Cl. B29C 33/38; B29C 33/12

(52) U.S. Cl. 264/219; 425/116

(57) ABSTRACT

A mold for making ceramic products (1) comprises at least two parts (2, 3) which can be coupled to each other to form, in a closed configuration, a cavity (4) for casting the ceramic product (1) by filling a liquid mixture (5) into it under pressure; internal constraining means (6) are positioned and operative between at least two inside surfaces (2a, 3a) of the mold (S) parts (2, 3), which form portions of the walls of the cavity (4) in order to keep the two parts (2, 3) securely in place after being positioned face to face relative to each other in the closed configuration; the internal constraining means (6) are made directly on the respective inside surfaces (2a, 3a) of the mold (S) parts (2, 3); the means (6) are designed to be interconnected, that is, to interpenetrate in such a way as to create a stable relative position between the mold (S) parts (2, 3).

### FIELD OF THE INVENTION

This invention relates to a porous mold for the manufacture of ceramic products, in particular for the manufacture of ceramic sanitaryware made using a process known as “solid casting”.

### BACKGROUND OF THE INVENTION

As is well known in this trade, ceramic sanitaryware (such as washbasins, toilet bowls, bidets and the like) are made by pressure casting a liquid mixture, known as slip, consisting of water, clay and very small quantities of other substances, in molds composed of a “shell” and “core” made of porous resin.

The mold gives the article of sanitaryware the required shape and after a certain length of time (necessary to draw out the water) the article is extracted from the mold in a solid form and further processed according to a well-known sequence of steps until it is completely finished.

Sanitaryware made in this way can be broadly divided into two main categories, namely: “solid cast” products and “liquid cast” products, as they are known in the jargon of the trade.

The first category of products (solid cast products, which this specification refers to in particular), typical examples of which are lidded cisterns mounted above the toilet bowl, are thus defined because the male and female parts of the mold have, along their normals, regular surfaces which are spaced from each other usually less than twice the thickness formed by one part of the mold. In other words, the main feature of solid cast products is that their walls are formed by two mold parts (a male and a female part) which are spaced from each other less than twice the thickness of each part of the mold.

Besides this, the cross section size of the cistern lid is greater than or equal to the cross section thickness of the cistern.

The second category of sanitaryware, that is, liquid cast sanitaryware allows maximum freedom of form for the cistern and lids (referring again to this type of product). The mold may have different dimensional ratios within it and the casting cavities may be very large.

It should be specified that solid cast products are not only products whose walls are all equal in thickness but also products, made to a specific design, where the product walls have zones of asymmetry. In practice, returning to the example of the solid cast cistern, a specific design might require the product wall thickness to be asymmetrical, differing for example between the right and left sides or between the “front” and “rear” side.

Returning, therefore, to solid cast products, and using as a non-limiting example of these a toilet cistern whose design specifications might require it to have equal or asymmetrical wall thicknesses, the product is made using two mold half-parts (a male half-part 2 and female half-part 3, as shown in FIGS. 1 and 2) which, in the closed configuration, form one or more cavities 4 (casting chamber) in which the product is formed.

When the mold is closed, the slip is filled into the mold cavity or cavities that will give the product its shape.

During the casting cycle, when the product walls acquire a certain thickness and become solid, the slip is subjected to suitable pressures which are in practice transferred to the walls of the two mold parts.

These pressures are balanced by a respective containment unit associated with the outside of the female part and are thus counteracted only by the surfaces that are directly correlated with the outside portion of the mold.

The surfaces of the male part of the mold usually interpenetrate the female part completely and are therefore subjected directly to the pressure of the slip.

The action of the pressure may lead to certain problems due precisely to the high pressure on the large projecting surfaces and resulting in the following on the internal surfaces:
an elastic or bending deformation effect leading to unwanted off-gauge thicknesses departing from design specifications;
possible damage to the male part of the mold.

The problem of unwanted off-gauge product wall thicknesses has a considerable effect on the economy of an installation, especially in the case of solid casting, and if wall thickness is not uniform or is asymmetrical to an incorrect extent (at least not within specified tolerances), the product must be rejected.

To this must be added the minor differences in the gauge of the mold cavity thicknesses due to the original shaping and production of the “mother mold” used to make the two parts of the mold. The bending effect of the male part of the mold tends to increase the wall thickness error.

It has been demonstrated in practice that this error often occurs along the same wall and, at present, in an attempt to reduce the number of reject products, material on the opposite side of the male part is eroded in order to compensate for the error, where possible. This allows a thickness value that is more acceptable but still not to original design specifications: in practice, the thicknesses are off-gauge and larger than originally decided.

As regards the problem of damage to the male part of the mold, the elastic or bending deformation effect subjects the zones where the projecting walls join the closing portion, perpendicular to the walls themselves, to high stress, eventually leading to fatigue failure of the male part of the mold.

To sum up, therefore, the current constructional characteristics of molds, in particular, but not limited to, those used for solid casting, are such that the mold structure cannot guarantee the stability of the internal walls and a relative balance that allows the ceramic products to be cast correctly.

### SUMMARY OF THE INVENTION

The main aim of this invention is therefore to overcome the above mentioned disadvantages by providing a porous mold for making ceramic products that is structured in such a way as to permit precise casting, constant in time, while at the same time increasing the operating “life” of the mold parts without excessively altering the original architecture of the mold.

Another aim of the invention is to obtain a precise and sure production of mold parts that avoids thickness gauge errors from the outset.

Accordingly, this invention achieves this aim by providing a porous mold, in particular a porous mold for the manufacture of ceramic products comprising two parts which can be coupled to each other to form, in a closed configuration, a cavity for casting the ceramic product by filling a liquid mixture into it under pressure.

Internal constraining means are positioned and operate between two inside surfaces of the parts of the mold which form portions of the cavity walls, in order to keep the two parts securely in place after being positioned face to face relative to each other in the closed configuration.

The fact that the constraining means are formed inside the cavity allows the parts to be securely and precisely coupled on the inside, while at the same time guaranteeing the correct positioning of the walls that form the cavity and hence shape the product.

Further, the presence of the constraining means inside the cavity makes it possible, during construction of the mold parts, to obtain a high level of precision in forming them, thereby significantly reducing mold construction errors.

These internal constraining means are made directly on the respective inside surfaces of the mold parts.

This feature allows these means to be added without altering the basic, internal-external structure of the mold and, above all, irrespective of whether mold is of the single or multiple type.

Moreover, in the closed configuration, these means can be interconnected, that is, can interpenetrate in such a way as to create a stable relative position between the mold parts.

That means stabilization occurs in a rapid, controlled and sure manner simultaneously with mold closure, that is to say, during the normal steps of the operating cycle.

### BRIEF DESCRIPTION OF THE DRAWINGS

The technical features of the invention, with reference to the above aims, are clearly described in the claims below and its advantages are more apparent from the detailed description which follows, with reference to the accompanying drawings which illustrate a preferred embodiment of the invention provided merely by way of example without restricting the scope of the inventive concept, and in which:

FIGS. 1 and 2 are a schematic side view and a bottom plan view, respectively, illustrating a prior art porous mold;

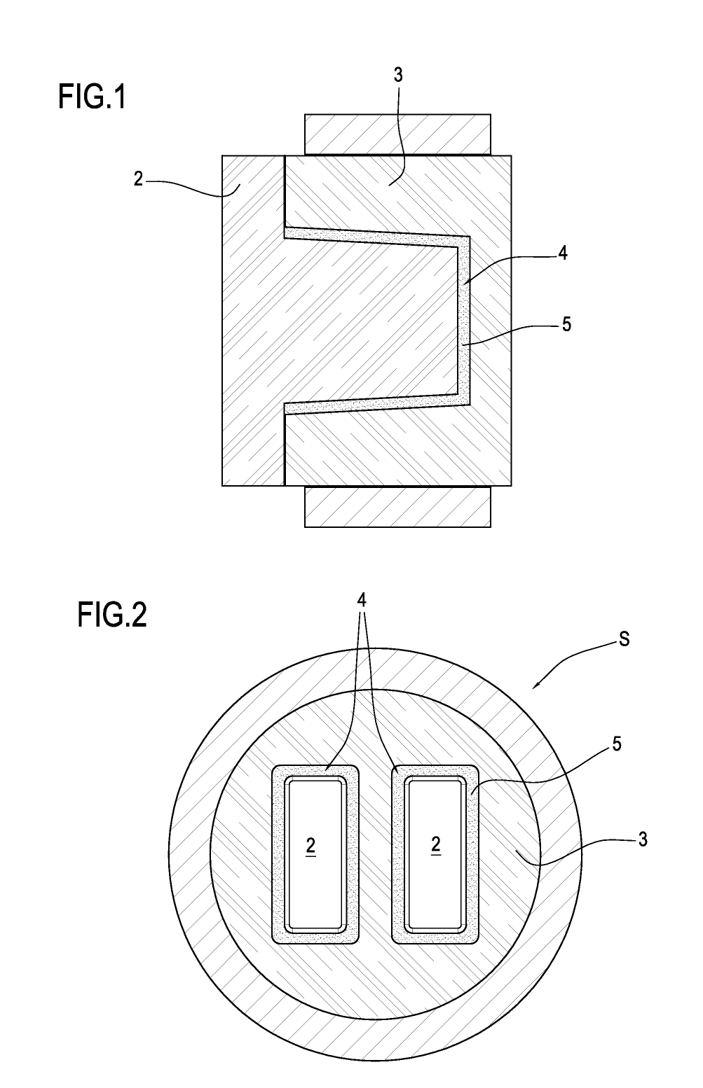

FIGS. 3 and 4 are a schematic side view and a bottom plan view, respectively, illustrating a porous mold according to this invention;

FIGS. 5 to 11 are schematic side views illustrating respective steps in the manufacture of a porous mold according to the invention;

FIG. 12 illustrates a scaled-up detail A from FIG. 3.

### DESCRIPTION OF THE PREFERRED EMBODIMENTS

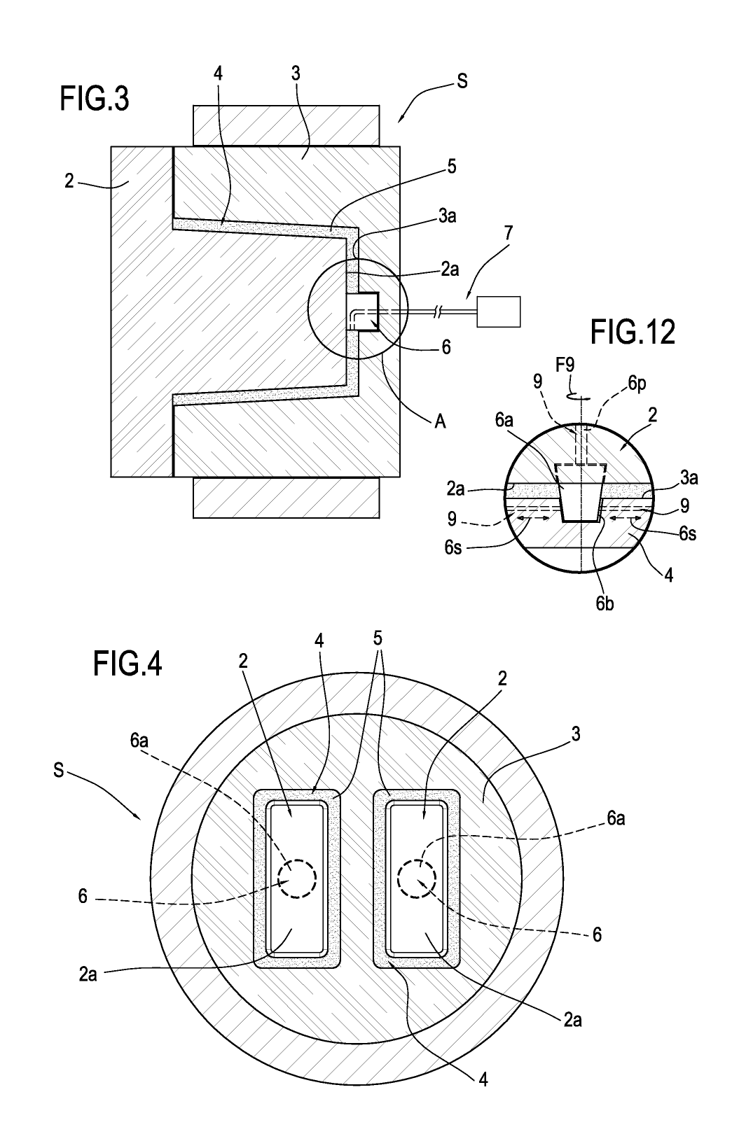

With reference to the accompanying drawings, in particular FIGS. 3 and 4, the porous mold S according to the invention is used for manufacturing ceramic products 1.

In particular, these molds S are made of porous resin and are used to make ceramic sanitaryware (such as washbasins, toilet bowls, bidets and the like) by pressure casting a liquid mixture 5, known as slip, consisting of water, clay and very small quantities of other substances, in these molds S which are composed of a “shell” and “core”.

In this description reference is made to an embodiment of the invention where the mold is used for products known in the jargon of the trade as “solid cast” products: this shall not, however, be deemed to limit the scope of the invention which can also be applied to the manufacture of molds having different structural characteristics, such as those used for “liquid cast” products.

Again with reference to FIGS. 3 and 4, the mold S for making ceramic products 1 according to the invention comprises at least two parts 2 and 3 which can be coupled to each other to form, in a closed configuration, a cavity 4 for casting the ceramic product 1 by filling the liquid mixture 5 into it under pressure.

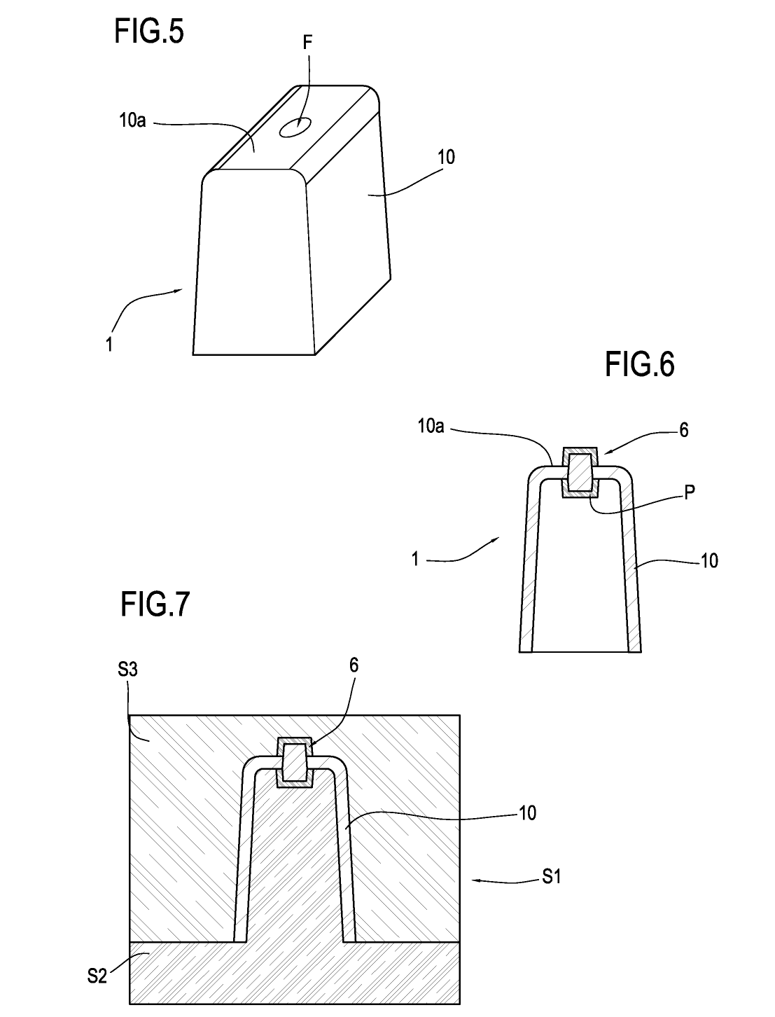

In the case illustrated by way of non-limiting example, the mold S forms a pair of cisterns (each of which will subsequently be provided with a lid and mounted, in use, above the toilet bowl, a pattern of the cistern being illustrated in upturned position in FIG. 5).

As clearly illustrated, again in FIGS. 3 and 4, internal constraining means 6 are positioned and operate between at least two inside surfaces 2a and 3a of the mold S parts 2, 3, forming the cavity 4, in order to keep the two parts 2 and 3 securely in place after being positioned face to face relative to each other in the closed configuration.

In other words, the mold S is also provided with internal constraining means 6 made directly on the respective inside surfaces 2a, 3a of the mold S parts 2, 3.

Further, in the closed configuration, the means 6 can be interconnected, that is, can interpenetrate in such a way as to create a stable relative position between the mold S parts 2, 3.

Thus, the presence of the internal constraining means 6 makes the position of the two parts 2 and 3 of the mold S when closed stable relative to each other, calibrated according to parameters set “at source” (that is to say, at the mold production stage, as we shall see in more detail below).

We have said that the mold S is also provided with the internal constraining means 6 because, as is known, the mold S is normally provided with an external system of constraint or containment during casting.

More specifically, the internal constraining means are located, as stated, on each of the internal surfaces 2a, 3a of the parts 2, 3 of the mold S which form the walls of the cavity 4.

That way they do not excessively affect the constructional architecture of the parts 2, 3 of the mold S. To this must be added that the constraining means 6 are located in the cavity 4 at or in the vicinity of a functional zone of the mold S.

Alternatively or in addition to the above location, the constraining means 6 might be located in the cavity 4 at a functional portion of the product 1, that is to say, to form or comprise an accessory functional for making the end product 1.

In other words, the constraining means 6 may form part of a zone 7 (of known type) for filling the liquid mixture 5 into the cavity 4 to make the product 1.

Similarly, in the case of cisterns, the constraining means 6 are located at a hole which will subsequently be used to connect the cistern to the toilet bowl.

In the case of other products, the constraining means 6 might be positioned on internal surfaces which form the cavity 4 of the product and which, in use, are hidden so that covering material can, if necessary, be applied without affecting the appearance of the product.

As mentioned above, again with reference to FIGS. 3 and 4, the internal constraining means 6 are located on each of the internal surfaces 2a, 3a of the parts 2, 3 of the mold S and can be coupled to each other in the closed configuration so as to place the parts 2, 3 of the mold S in a stable position relative to each other.

In short, in the non-limiting example illustrated, a first part 2, referred to as the male part, is partly housed in the second part 3, referred to as the female part, in such a way as to present at least one bottom surface 2a that faces the respective bottom surface 3a of the second, female part 3.

The constraining means 6 may, as we shall see below, be made as one with the respective parts 2, 3 of the mold S, or without limiting the scope of the inventive concept, they may be applied to the parts 2, 3.

Similarly, the constraining means 6 may be made of the same material as the mold S or they may be made of plastic or metal, depending on the design requirements of the mold S.

In the specific case illustrated here, therefore, the bottom surface 2a of the first, male part 2 has a protruding pin 6a that can be coupled stably to a respective socket 6b made in the bottom surface 3a of the second, female part 3.

It is obvious that, alternatively, the socket 6b may be made in the first, male part 2, and the pin 6a on the second, female part 3 without thereby limiting the scope of the invention.

Although the pin 6a and the socket 6b may advantageously, but without limiting the invention, have the shape of a truncated cone, obviously the pin may have any of several other different shapes without the invention losing its originality.

Again by way of example, the pin 6a and the socket 6b may each be formed as one with the respective part 2, 3 of the mold S.

Alternatively, the pin 6a may be removably associated with the respective male part 2 of the mold S before being used for the casting process.

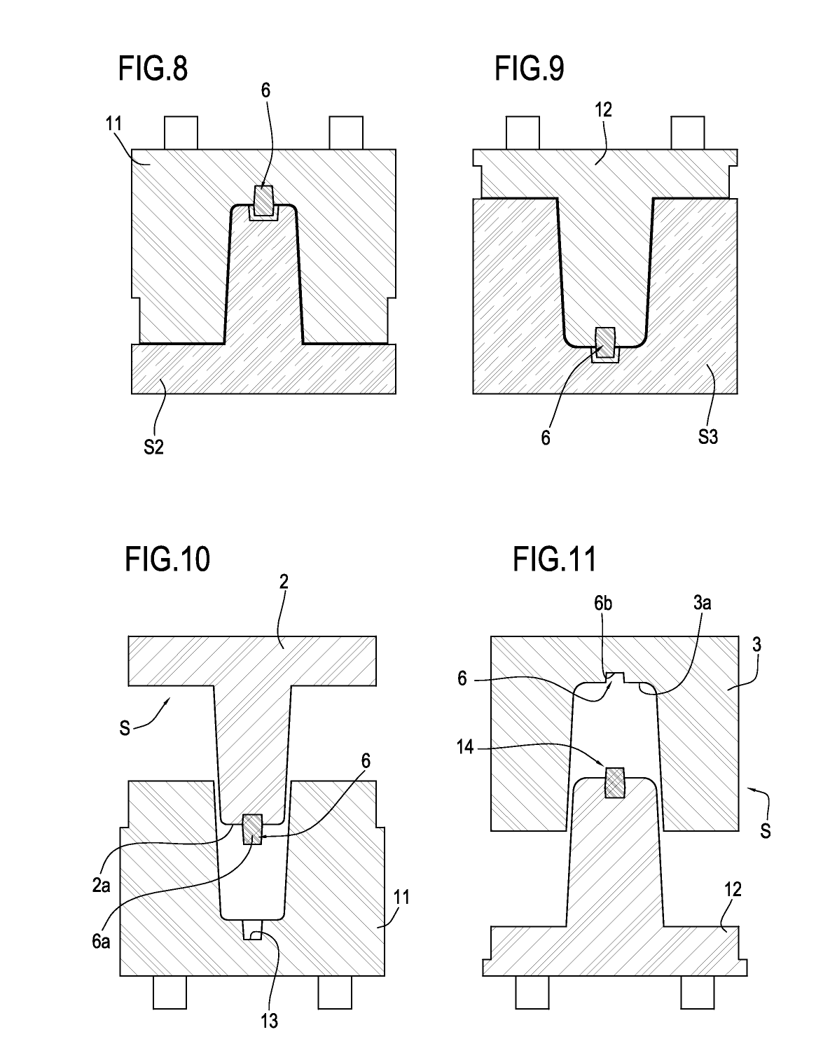

In another embodiment of the constraining means 6 (see FIG. 12) adjustment means 9 may be provided between the pin 6a and the socket 6b to vary, if necessary, the position of the first and second parts 2 and 3 of the mold S relative to each other.

As a schematic example, the adjustment means 9 might comprise the pin 6a itself, made in eccentric form and in such a way that it can rotate (arrow F9, FIG. 12) about its axis (thanks to a rotatable pin 6p inserted in the part of the mold S) in such a way as to vary the relative position of the two parts 2, 3 according to the angle of rotation of the pin 6a with respect to the socket 6b.

In yet another embodiment (again see FIG. 12) the pin 6a might be made to move radially within the socket 6b by suitable thrust shims 6s located in the respective part (in this case the female part 3) of the mold S and able to be adjusted from the outside of the mold itself.

Obviously, these adjustments would be very limited in extent and due to operating needs, such as for example the need to vary the thicknesses of the product 1 to meet specifications.

FIGS. 5 to 11 schematically represent two example methods of making a porous mold S as described up to here.

A first method might comprise at least the following steps:
creating a pattern 10 of the ceramic product 1 to be manufactured (FIG. 5);
forming and/or applying constraining means 6 on the pattern 10 (FIG. 6);
producing the mold S directly from the pattern 10, said mold comprising a first and a second part 2 and 3 having respective zones fitted with the constraining means 6.

This is made possible by the fact that both the pattern 10 and the mold S can be created using computer aided modeling techniques (for example, three dimensional CAD-CAM).

A second, traditional method, on the other hand, comprises further steps, after creating the pattern 10 equipped with the constraining means 6 and before producing the final mold S.

These further steps comprise the following:
producing a gypsum mold S1 in two parts S2, S3, based on the pattern 10 equipped with the constraining means 6, in such a way as to define the relative position between the parts of the mold S1 with respective zones equipped with the constraining means 6 (FIG. 7);
producing a first part of a mother mold or matrix 11 for making the first, male part 2 of the porous mold S from the respective part S2 of the gypsum mold and forming or applying the respective part 6a of the constraining means 6 (FIG. 8);
producing a second part of a mother mold or matrix 12 for making the second, female part 3 of the porous mold S from the respective part S3 of the gypsum mold and forming or applying the respective part 6b of the constraining means (FIG. 9).

At this point, once the matrices 11 have been made, the two parts of the mold S, namely, the male part 2 (FIG. 10) and the female part 3 (FIG. 11) can be made and are ready-fitted with the constraining means 6.

Going back now to FIG. 6, the step of forming and/or applying the constraining means 6 on the pattern comprises, in the embodiment described up to now, making a through hole F (functional for the cistern that will eventually be cast) in a surface 10a of the pattern 10 and applying a pin P protruding from both ends of the hole F, that is to say, from both sides of the surface 10a.

In this way, during the step of producing the male and female mother mold or matrix parts 11 and 12, two parts are created, the first equipped with a cavity or hole 13, and the second equipped with a protrusion or pin 14, constituting the “negatives” of the constraining means 6 and which, in the next step of making the first and second, male and female parts 2 and 3 of the porous mold S, form the constraining means 6 proper.

Obviously, as already mentioned in the description of the constraining means 6 themselves, if the pin 6a is designed on the female part 3 and the socket 6b on the male part 2, the corresponding negative hole 13 and protrusion 14 will be located, in reverse, on the mother mold or matrix parts 11 and 12, without thereby limiting the scope of the invention in any way.

A mold thus made and the related method of producing it achieve the above mentioned aims thanks to an optimized and non-invasive internal system of calibrating the mold parts.

The presence of the constraining means inside the mold cavity offers considerable advantages:
high precision over time in the manufacture of the ceramic products, whether solid cast or liquid cast;
flexibility in the application of the constraining means which can be fitted in the most convenient position, depending on the type of product to be made, without reducing the aesthetic quality of the end product;
low production costs both for the mold and the parts needed for modeling the parts of the mold;
longer mold operating life thanks to the increased stability of mold parts;
the creation of the constraining means as early as the pattern stage reduces the risk of imprecision in the subsequent production of the mold parts, created directly from the pattern, and of the gypsum mold and matrices, so as to immediately calibrate all the parts that combine in the modeling process;
the design process is extremely precise even where specifications require the end product to have zones of asymmetry.

That means, also, that the structure of the constraining means can be decided from the outset according to the type of product to be made and the mold used to make it.

The invention described above is susceptible of industrial application and may be modified and adapted in several ways without thereby departing from the scope of the inventive concept. Moreover, all the details of the invention may be substituted by technically equivalent elements.

1. A mold for making ceramic products (1), the mold (S) being of the type comprising at least two parts (2, 3) which can be coupled to each other to form, in a closed configuration, a cavity (4) for casting the ceramic product (1) by filling a liquid mixture (5) into it under pressure; characterized in that internal constraining means (6) are positioned and operative between at least two inside surfaces (2a, 3a) of the mold (S) parts (2, 3), which form portions of the walls of the cavity (4) in order to keep the two parts (2, 3) securely in place after being positioned face to face relative to each other in the closed configuration; the internal constraining means (6) being made directly on the respective inside surfaces (2a, 3a) of the mold (S) parts (2, 3) and being designed to be interconnected, that is, to interpenetrate in such a way as to create a stable relative position between the mold (S) parts (2, 3).

2. The mold according to claim 1, wherein the constraining means (6) are located in the cavity (4) at a functional zone of the mold (S).

3. The mold according to claim 1, wherein the constraining means (6) are located in the cavity (4) at a functional portion of the product (1), that is to say, to form or comprise an accessory functional for making the end product (1).

4. The mold according to claim 3, wherein the constraining means (6) comprise a zone (7) for filling the liquid mixture (5) into the cavity (4) to make the product (1).

5. The mold according to claim 1, where the first, male part (2), is partly housed in the second, female part (3), in such a way as to present at least one bottom surface (2a) that faces the respective bottom surface (3a) of the second, female part (3), wherein the bottom surface (2a) of the first, male part (2) has a protruding pin (6a) that can be coupled stably to a respective socket (6b) made in the bottom surface (3a) of the second, female part (3).

6. The mold according to claim 5, wherein the pin (6a) and the socket (6b) have the shape of a truncated cone.

7. The mold according to claim 5, wherein the pin (6a) and the socket (6b) are formed as one with the respective parts (2, 3) of the mold (S).

8. The mold according to claim 5, wherein at least the pin (6a) is removably associated with the respective part (2) of the mold (S).

9. The mold according to claim 5, comprising adjustment means (9) between the pin (6a) and the socket (6b) to vary the position of the first part (2) and the second part (3) of the mold (S) relative to each other.

10. A method for making a porous mold (S) for manufacturing ceramic products (1) according to claim 1 comprising at least the following steps:
creating a pattern (10) of the ceramic product (1) to be manufactured;
forming and/or applying constraining means (6) on the pattern (10);
producing the mold (S) based on the shape of the pattern (10), said mold comprising at least a first and a second part (2, 3) having respective zones fitted with the constraining means (6).

11. The method according to claim 10, wherein, after the step of forming and/or applying the constraining means (6) on the pattern (10) and before the step of producing the mold (S), it further comprises at least the following steps:
producing a gypsum mold (S1) in two parts (S2, S3), based on the pattern (10) equipped with the constraining means (6), in such a way as to define the relative position between the parts of the gypsum mold (S1) having respective zones equipped with the constraining means (6);
producing a first part of a mother mold or matrix (11) for making the first, male part (2) of the porous mold (S) from the respective part (S2) of the gypsum mold and forming or applying the respective part (6a) of the constraining means (6);
producing a second part of a mother mold or matrix (12) for making the second, female part (3) of the porous mold (S) from the respective part (S3) of the gypsum mold and forming or applying the respective part (6b) of the constraining means.

12. The method according to claim 10, wherein the step of forming and/or applying constraining means (6) on the pattern (10) comprises making a through hole (F) in a surface (10a) of the pattern (10) and applying a pin (P) protruding from both ends of the hole (F), that is to say, from both sides of the surface (10a).

13. The method according to claim 11, wherein during the step of producing the male and female mother mold or matrix parts (11, 12), two parts are created, the first equipped with a cavity or hole (13), and the second equipped with a protrusion or pin (14), constituting the negatives of the constraining means (6) and which, in the next step of making the first and second, male and female parts (2, 3) of the porous mold (S), form the constraining means (6).
